(19) United States
(12) Patent Application Publication
(10) Pub. No.: US 2002/0072979 A1
(43) Pub. Date: Jun. 13, 2002

(54) System and web-based method for selecting panelboard configurations

(76) Inventors: Anil Sinha, Vienna, VA (US); Loknath Esety Patro, Plainville, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,457

(22) Filed: Apr. 10, 2001

Related U.S. Application Data
(60) Provisional application No. 60/195,917, filed on Apr. 10, 2000.

(51) Int. Cl. G06F 17/60

(52) U.S. Cl. 705/26

(57) ABSTRACT

A web-based method for identifying panelboards includes receiving panelboard specification information from a user and utilizing a server to compare the received specification information with pre-stored information. The method also includes selecting at least one panelboard which matches the received specification information and downloading to the user information related to the panelboard.

CROSS REFERENCE TO RELATED APPLICATIONS

This application claims the benefit of U.S. Provisional Application No. 60/195,917 filed Apr. 10, 2000.

### COPYRIGHT STATEMENT

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

This invention relates generally to computer network-based wizards and more particularly to a network-based system and method for identifying panelboard configurations and costs associated therewith.

Panelboards are utilized to mount electrical wires thereon. Typically, a panelboard includes fuses or circuit breakers which protect against over current and resulting damage to electrical wiring. The panelboards provide a single location from which to access over current protectors for a facility.

Identifying a correct panelboard for a specific application is not always an easy task. Many parameters should be considered, and each combination of parameters could demand a specific panelboard for optimum performance.

Therefore, it would be desirable to quickly determine a proper panelboard that should be utilized for different combinations of parameters. In addition, it would be desirable to determine if a particular panelboard provides inadequate performance for equipment, machinery, or a facility.

### SUMMARY OF INVENTION

In an exemplary embodiment, a web-based method for selecting a panelboard includes receiving product specification information from a user and comparing the received product specification information with pre-stored panelboard information. If at least one panelboard matches the received product specification information, the pre-stored panelboard information is downloaded for communication to the user.

The product specification information may include, for example, interior features of the product, panel build features of the product, branch breakers of the product, and accessories of the product. The method further includes validating configuration compatibility based on product information data and features of the product to determine whether a resulting product is capable of desired performance for a set of given product parameters.

### BRIEF DESCRIPTION OF DRAWINGS

FIG. 1 is a schematic diagram of an exemplary network structure embodying a method for selecting panelboard configurations.

FIG. 2 is an expanded version block diagram of an exemplary embodiment of a server architecture of a system for implementing the network-based method for selecting panelboard configurations.

FIG. 3 is a flow diagram of a web-based method for selecting and ordering panel boards.

FIG. 4 is an exemplary panelboards needs analysis page.

FIG. 5 is an exemplary panelboards interior features page.

FIG. 6 is an exemplary add to cart new order message page.

FIG. 7 is an exemplary shopping cart page.

FIG. 8 is an exemplary panelboards panel build page.

FIG. 9 is a continuation of the exemplary panelboards panel build page shown in FIG. 8.

FIG. 10 is an exemplary panelboards branch breaker page.

FIG. 11 is an exemplary exception message page.

FIG. 12 is a further exemplary exception message page.

FIG. 13 is an exemplary panelboards accessories page.

FIG. 14 is an exemplary line drawing page.

### DETAILED DESCRIPTION

Exemplary embodiments of systems and methods for facilitating selection of panelboard configuration are described below in detail. The systems and methods facilitate, for example, selection of an appropriately configured panelboard and provides recommendations when incompatible configurations are chosen.

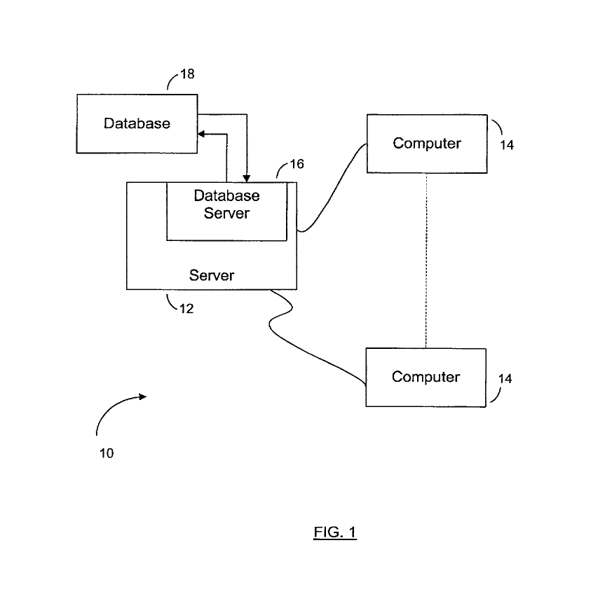

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a network browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. Server 12 includes a database server 16 connected to a centralized database 18 containing panelboard information. In one embodiment, centralized database 18 is stored on database server 16 and can be accessed by potential users at one of user devices 14 by logging onto server subsystem 12 through one of user devices 14. In an alternative embodiment centralized database 18 is stored remotely from server 12.

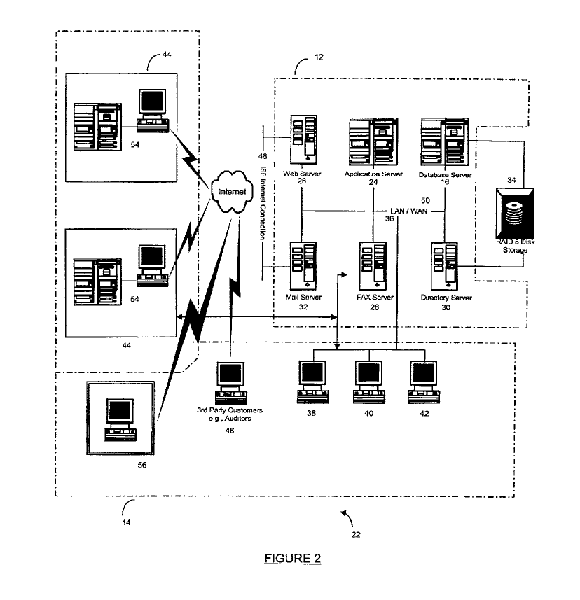

FIG. 2 is an expanded version block diagram of an exemplary embodiment of a server architecture of a system 22. System 22 includes server sub-system 12 and user devices 14. Server sub-system 12 includes database server 16, an application server 24, a network server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a network browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in an exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In an exemplary embodiment, any employee 44 or user 46 having a workstation 52 can access server sub-system 12. One of user devices 14 includes a workstation 54 located at a remote location. Workstations 52 and 54 are personal computers having a network browser. Also, workstations 52 and 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

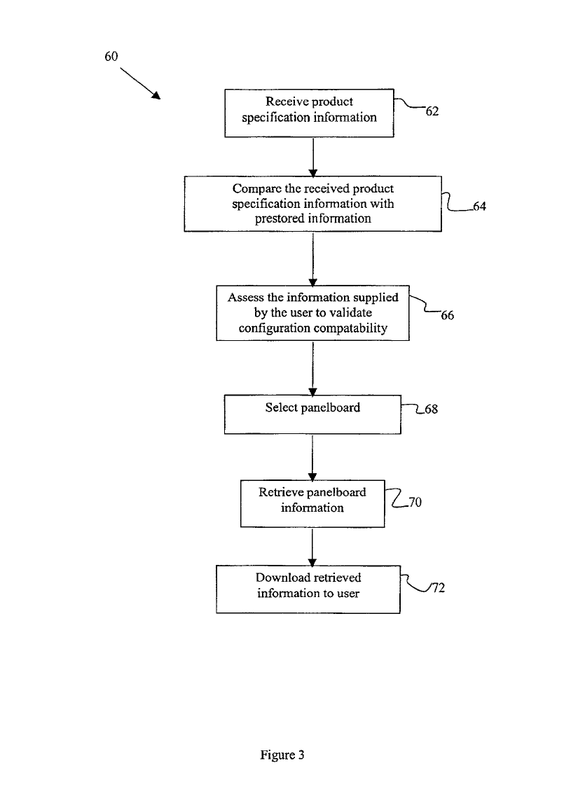

FIG. 3 is a flow diagram 60 for a web-based method for selecting and ordering panelboards. In one embodiment, the panelboards are industrial panelboards. In an alternative embodiment, the panelboards are commercial panelboards. In a further alternative embodiment, the panelboards are residential panelboards. System 10 (shown in FIG. 1) receives 62 product specification information from a user. In one embodiment, the user inputs the information into a device (such as device 14 shown in FIG. 1) which transmits the information to a server (such as server 12 shown in FIG. 1). The product specification information is received from the user via a graphical user interface as will be described in greater detail below.

The received product specification information includes an identification of panelboard features, build panel features, branch breaker features, and an identification of accessories for the product. Exemplary panelboard features include, but are not limited to, phase selection, e.g., single phase or three phase, voltage rating, incoming amperage, number of circuits, and bus material. Exemplary build panel features include, but are not limited to, main, feed-thru, and enclosure. Exemplary main panel build features include, but are not limited to, main device, interrupt rating, and lug style. Exemplary feed-thru panel build features include, but are not limited to, feed-thru options, feed-thru amperage, feed-thru interrupt rating, and lug/TVSS. Exemplary enclosure panel build features include, but are not limited to, box and front. Exemplary branch breaker features include, but are not limited to, branch breaker interrupt rating, and a quantity, amps and poles for each breaker. Exemplary product accessories features include, but are not limited to, knock out endwalls, service entrance label, 200% neutral, and ground.

Server 12 compares 64 the received information to pre-stored information accessible by server 12. In one embodiment, the pre-stored information is stored in database 18 that resides on server 12. In an alternative embodiment, the pre-stored information is stored in a database remote from server 12. The pre-stored information includes the panelboard features, build panel features, branch breaker features, and an identification of accessories for the product. Server 12 compares the received information to the pre-stored information to determine if any panelboards contained in the pre-stored information satisfy the product specifications submitted by the user.

In addition, system 12 assesses 66 the information supplied by the user to validate configuration compatibility of the product. Exemplary information includes product application, product parameters, desired product features, and product accessories. System 10 evaluates the information supplied by the user and determines whether a resulting product incorporating a panelboard having the received product specifications is capable of meeting parameters of the indicated product. For example, system 10 determines whether a selected bus material is available for the selected panelboard configuration and, if the selected bus material is not available for the selected panelboard configuration, system 10 displays a message to the user that the selected bus material is not available for the selected panelboard configuration. As another example, system 10 determines whether a selected number of circuits is available for the selected panelboard configuration and, if a panelboard is suggested that has a larger number of circuits available than the number of circuits selected, system 10 displays a message to the user that a panelboard having a larger number of circuits available than the number of circuits selected is available for the selected panelboard configuration.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored panelboard information that matches the information entered by the user and selects 68 those panelboards pertaining to that pre-stored information. System 10 retrieves 70 panelboard information pertaining to the selected panelboard. In one embodiment, the panelboard information includes a panelboard identifier number and associated price for each selected panelboard. For example, the panelboard identifier number is a catalog number and the price is a list price of the product. Server 12 then transmits the retrieved panelboard identifier number and associated price and downloads 72 the retrieved information to user device 14 so that the user can view the information. In an alternative embodiment, system 10 utilizes the list price information to generate a quotation for each selected panelboard including the indicated features and accessories and server 12 then transmits the retrieved panelboard identifier number and the quotation to user device 14.

System 10 then prompts the user to order one or more of the selected products. If the user is a registered user, system 10 accepts orders online by providing the user a purchase order form and receiving the completed purchase order form from the user. The completed purchase order form is then authenticated against pre-determined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person then checks the order and instructs system 10 to transmit the order to a field sales regional manager or district manager. The field sales manager follows-up with the lead or forwards the lead to a distributor with instructions to follow-up with the user that submitted the order.

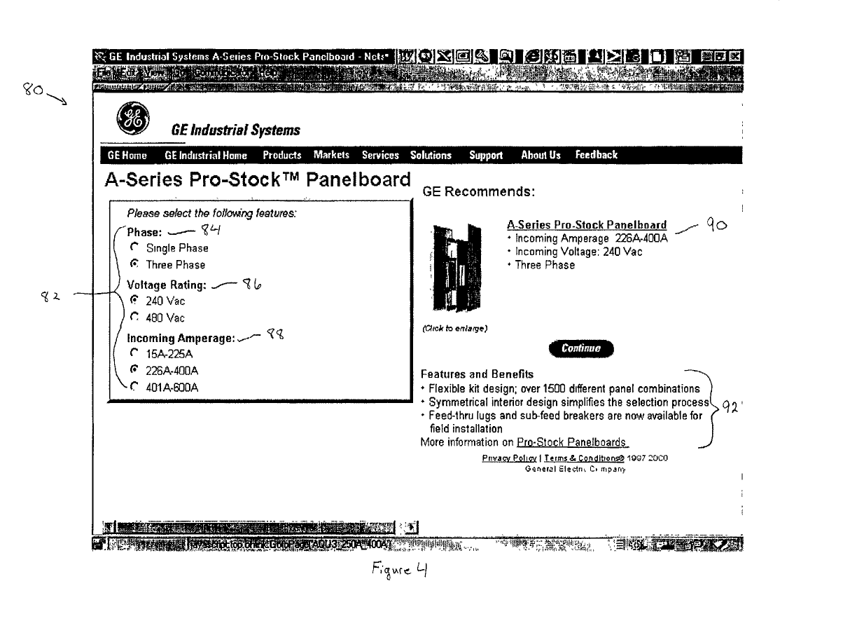

FIGS. 4 through 14 detail navigation through an exemplary web-site linked to system 10 (shown in FIG. 1) via device 14 (shown in FIG. 1) and server 12 (shown in FIG. 1). For example, FIG. 4 is an exemplary needs analysis page 80 downloaded and displayed on device 14 by server 12 when a user decides to order, or obtain additional information, on panelboards by selecting a panelboard help area (not shown) or a solutions engine area (not shown) on a home page (not shown) of a business entity. Once either the panelboard help area or the solutions engine area is selected by the user, system 10 downloads a second user interface (not shown in FIG. 4) onto user device 14. Needs analysis page 80 includes a plurality of check buttons 82 to be utilized when supplying information to system 10. Check buttons 82 are included for phase selection 84, voltage rating 86, and incoming amperage 88. System 10 then downloads information regarding a suitable panelboard 90 that includes the selected features and a features and benefits section 92 that details the features and benefits of the suitable panelboard.

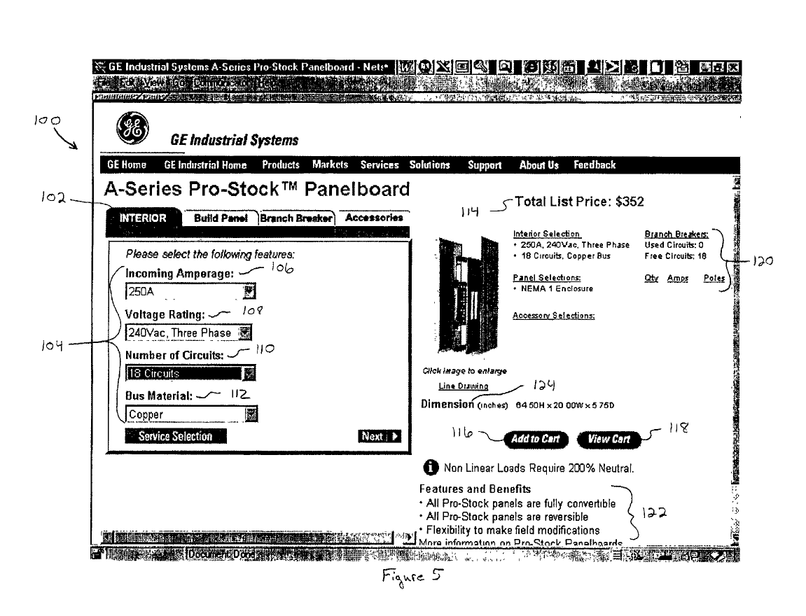

FIG. 5 is an exemplary panelboards interior features page 100 including an interior features tab 102 that includes a plurality of pull down menus 104 to be utilized when supplying information to system 10 (shown in FIG. 1). Pull down menus 104 are supplied for incoming amperage 106, voltage rating 108, number of circuits 110, and bus material 112. A list price 114 is then displayed to the user. The user has the option of selecting an Add to Cart button 116 or a View Cart button 118.

Features page 100 also displays all selected features 120 for the indicated product. A warning section (not shown) is displayed on features page 100 which indicates relevant information for the selected configuration. Also, a features and benefits section 122 is included on features page 100 that details the benefits of the selected configuration. In addition, a dimension 124 of the selected product is displayed that indicates the height, width, and depth of the selected product.

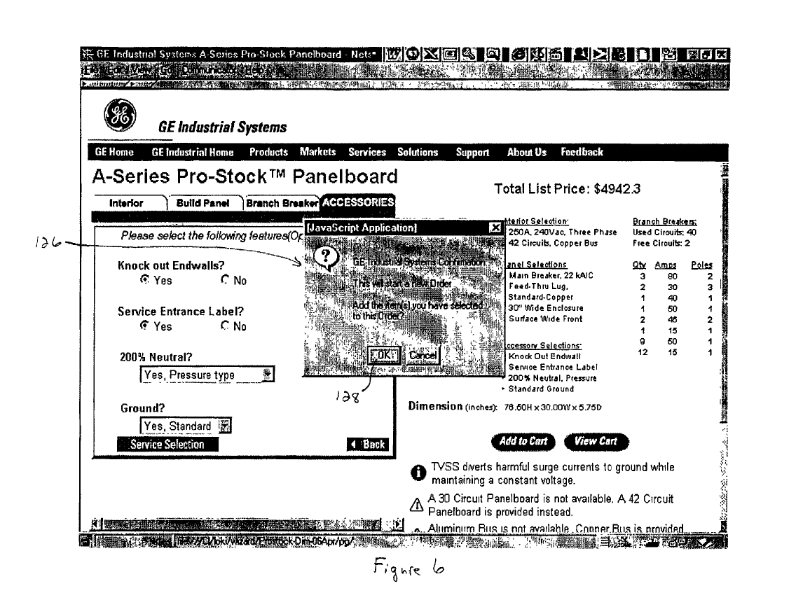

If the user selects Add to Cart button 116, an add to cart new order message page (not shown in FIG. 5) is downloaded and displayed on device 14 by server 12. For example, FIG. 6 is an exemplary add to cart new order message page 126. Page 126 informs the user that the selected items will be added to a new order. Page 126 includes an OK button 128 that if selected, transfers the user to a shopping cart page (not shown in FIG. 6).

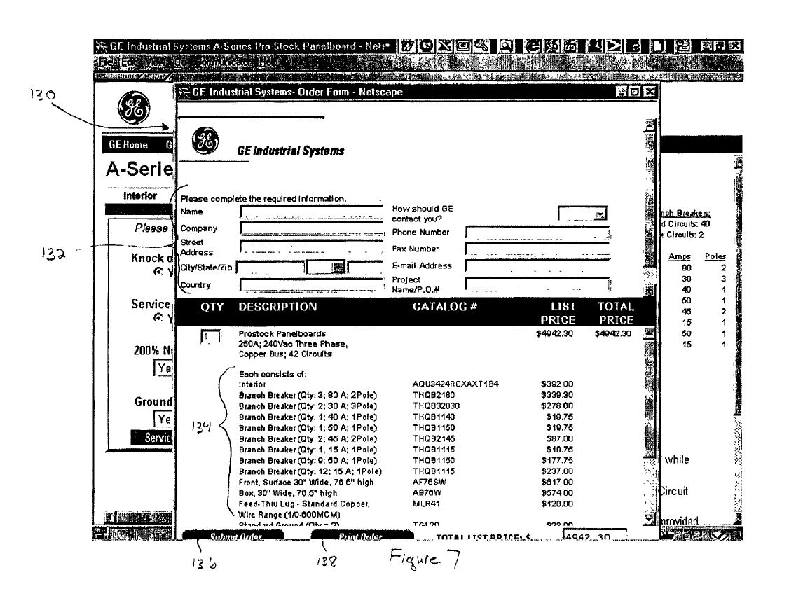

FIG. 7 is an exemplary shopping cart page 130 that includes a plurality of information blocks 132 to be completed by the user. In addition, shopping cart page 130 includes a listing of panelboard components 134, including the selected features, and a listing of accessories (not shown) that the user has ordered. If the user is a registered user, system 10 accepts an online order when the user selects a Submit Order button 136. In addition, the user can print the order by selecting a Print Order button 138.

If the user is an unregistered user, system 10 transmits a notification (not shown) to the user, as explained above. Alternatively, the user can select a Clear Order button (not shown) which clears the listed orders from the screen or the user can select a Close button (not shown) which closes shopping cart page 130 and sends the user back to panelboard interior features page 100 (shown in FIG. 5). In a further alternative embodiment, the user selects a Where to Buy button (not shown) which provides a listing of businesses and a location of the businesses that sell the requested panelboards and any related products.

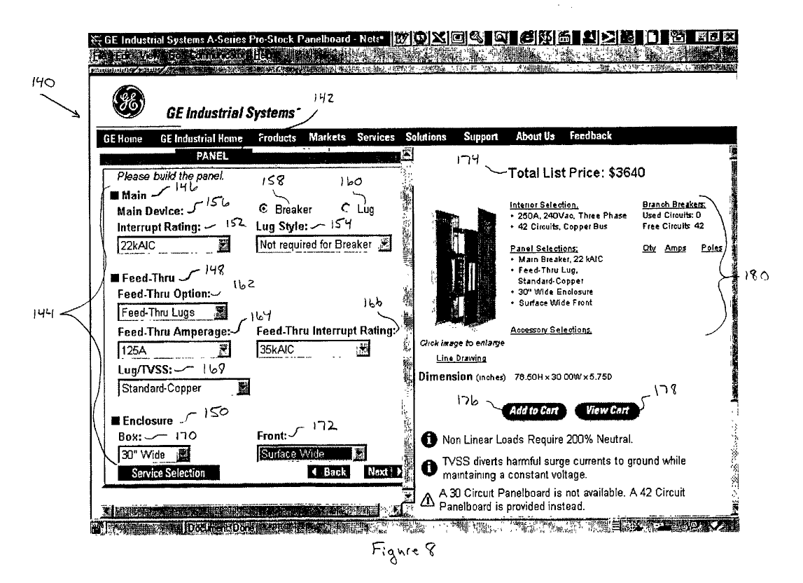

FIG. 8 is an exemplary panelboards build panel page 140 including a panelboards build panel tab 142 that includes a plurality of pull down menus 144 to be utilized when supplying information to system 10 (shown in FIG. 1). Pull down menus 144 are supplied for three categories, main 146, feed-thru 148, and enclosure 150. Panelboard main 146 includes pull down menus for interrupt rating 152 and lug style 154. Panelboard main 146 also includes a check button for main device 156, e.g., breaker 158 and lug 160. Panelboard feed-thru 148 includes pull down menus for feed-thru option 162, feed-thru amperage 164, feed-thru interrupt rating 166, and lug/TVSS 168. Panelboard enclosure 150 includes box 170 and front 172.

An updated list price 174 is then displayed to the user. The user has the option of selecting an Add to Cart button 176 or a View Cart button 178. Panelboard build page 140 also displays all selected features 180 which include any additional features selected for the indicated product.

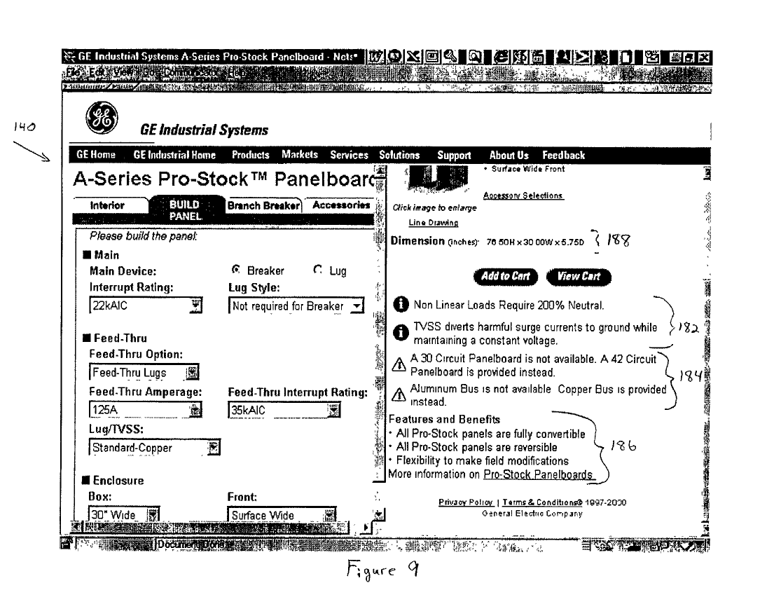

FIG. 9 is a continuation of panelboard build panel page 140 and includes a caution section 182 and a warning section 184 which indicate relevant information for the selected configuration. Also, a features and benefits section 186 is included on build panel page 140 that details the benefits of the selected configuration. In addition, a dimension 188 of the selected product is displayed that indicates the height, width, and depth of the selected product.

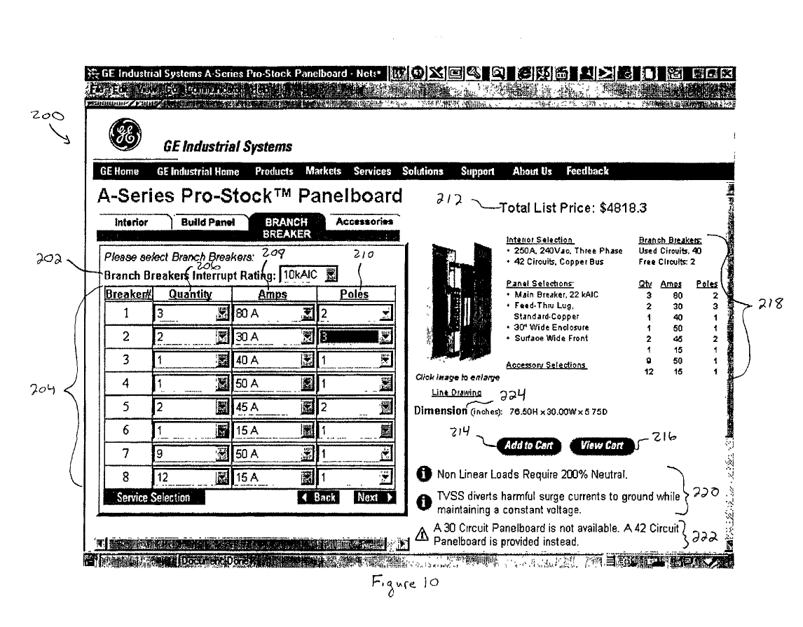

FIG. 10 is an exemplary panelboards branch breaker page 200 including a pull down menu for a branch breakers interrupt rating 202. In addition, branch breaker page 200 includes a plurality of pull down menus 204 associated with the specific breaker number. Pull down menus 204 are supplied for quantity 206, amps 208, and poles 210. An updated list price 212 is then displayed to the user. The user has the option of selecting an Add to Cart button 214 or a View Cart button 216.

Branch breaker page 200 also displays all selected features 218 for the indicated product. A caution section 220 and a warning section 222 are displayed on branch breaker page 200 which indicate relevant information for the selected configuration. Also, a features and benefits section (not shown) is included on branch breaker page 200 that details the benefits of the selected configuration. In addition, a dimension 224 of the selected product is displayed that indicates the height, width, and depth of the selected product.

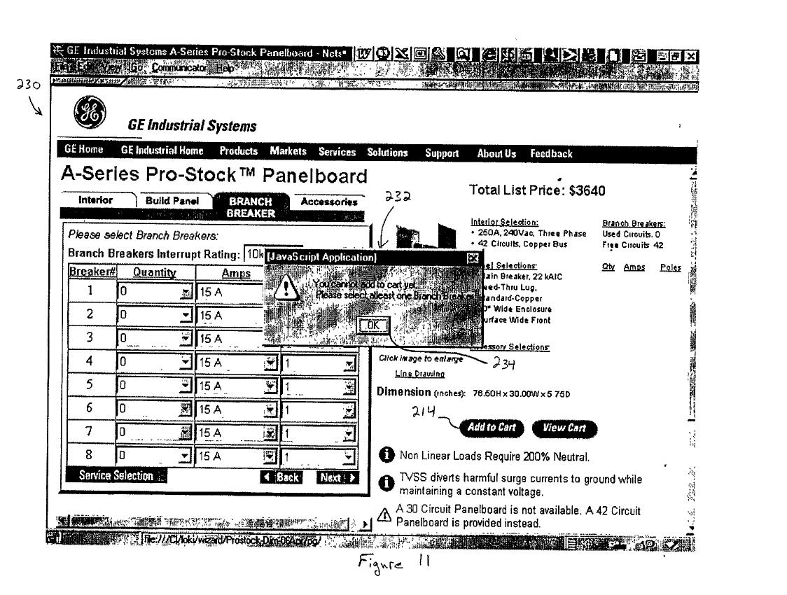

FIG. 11 is an exemplary exception message page 230 illustrating a message 232 transmitted by system 10 (shown in FIG. 1) if add to cart button 214 is selected before at least one branch breaker has been selected. Once the user selects OK button 234, system 10 again downloads branch breaker page 200 (shown in FIG. 9) onto device 14 (shown in FIG. 1). In an alternative embodiment, an other messages page (not shown) is displayed by system 10 when an accessory is suggested to be used with the selected panelboard. The other messages page includes a message (not shown) that indicates a certain accessory is suggested for use with the selected panelboard.

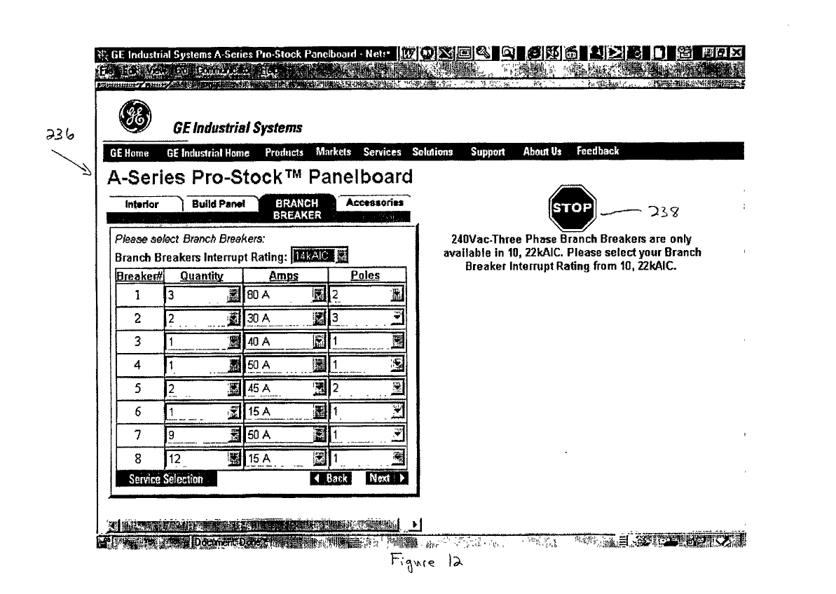

FIG. 12 is a further exemplary exception message page 236 illustrating a warning message 238. Message 238 indicates that three phase branch breakers are only available in 10, 22 kAIC. Message 238 further indicates to the user that a branch breaker interrupt rating from 10, 22 kAIC should be chosen. Message 238 is displayed to alert the user that an incompatibility exists between the selected configuration and actual possible configurations.

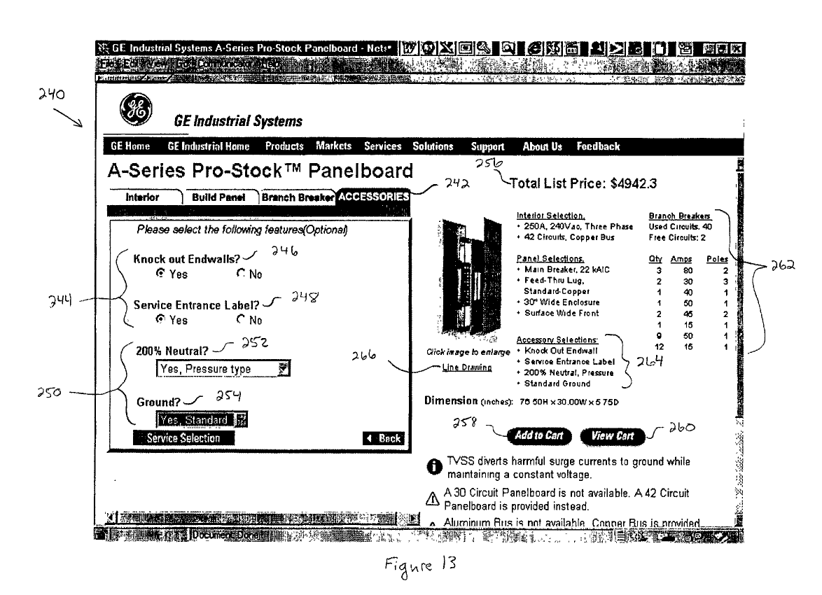

FIG. 13 is an exemplary panelboards accessories page 240 illustrating an accessories features tab 242 selected by the user. Accessories features tab 242 includes a plurality of check buttons 244 to be utilized when supplying information to system 10 (shown in FIG. 1). Check buttons 244 include a knock out endwalls 246 and service entrance label 248. In addition, accessories features tab 242 includes pull down menus 250 for 200% neutral 252 and ground 254.

An updated list price 256 is then displayed to the user. In an alternative embodiment, an updated catalog number (not shown) is also displayed by system 10. At this point, the user has the option of selecting an Add to Cart button 258 or a View Cart button 260. Page 240 also displays all selected features 262 and all selected accessories 264 for the indicated product. Page 240 further displays a line drawing 266 option.

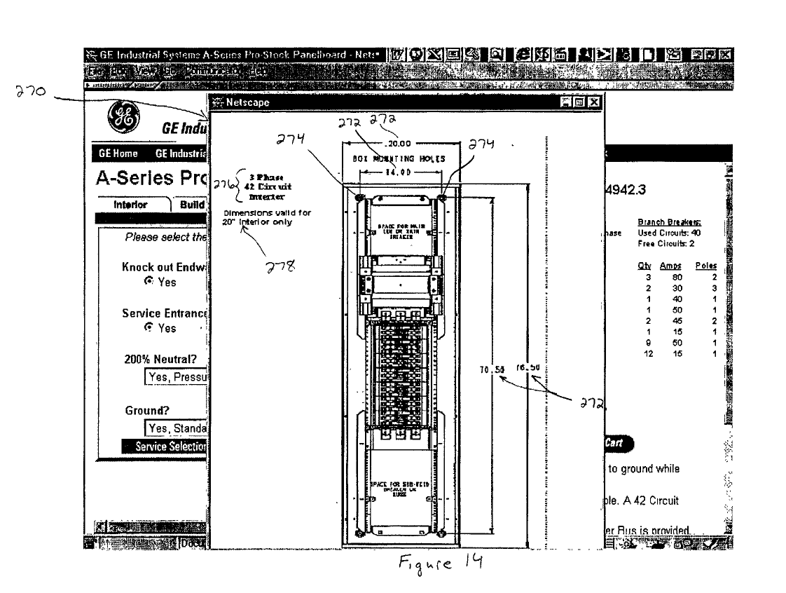

FIG. 14 is an exemplary line drawing page 270 that illustrates a line drawing of the selected panelboard configuration 272. Panelboard configuration 272 includes a plurality of dimensions 274 that indicate a size of the selected configuration. In addition, panelboard configuration 272 include mounting holes 276 that illustrate how configuration 272 is to be mounted. Page 270 includes an interior features section 276 and a cautionary statement 278.

System 10 facilitates an easy and efficient method for identifying and ordering panelboards. System 10 is network based and is configured to permit users to access system 10 from remote locations through devices 14.

While the invention has been described in terms of various specific embodiments, those skilled in the art will recognize that the invention can be practiced with modification within the spirit and scope of the claims.

1] a method for facilitating selection of a panelboard for a product using a network-based system including a server and at least one device connected to the server via a network, said method comprising the steps of:
receiving product specification information from a user via the device;
comparing the received product specification information with pre-stored panelboard information;
selecting at least one panelboard which matches the received product specification information; and
downloading information related to the panelboard.

2] A method according to claim 1 wherein said step of receiving product specification information comprises the step of receiving panelboard interior information for the product.

3] A method according to claim 1 further comprising the step of providing a recommendation regarding a suitable panelboard.

4] A method according to claim 1 wherein said step of receiving product specification information comprises the step of receiving panelboard information including at least one of an incoming amperage, voltage rating, number of circuits, and bus material.

5] A method according to claim 4 wherein said step of comparing the received product specification information comprises the steps of:
determining whether the bus material selected is available for the selected panelboard configuration; and
displaying a message if the selected bus material is not available for the selected panelboard configuration.

6] A method according to claim 4 wherein said step of comparing the received product specification information comprises the steps of:
determining whether a selected number of circuits is available for the selected panelboard configuration; and
displaying a message if a panelboard is suggested that has a larger number of circuits available than the number of circuits selected.

7] A method according to claim 1 wherein said step of receiving product specification information comprises the step of receiving panelboard information including at least one of main, feed-thru, and enclosure.

8] A method according to claim 7 wherein said step of receiving panelboard information comprises the step of receiving main panelboard information including at least one of main device, interrupt rating, and lug style.

9] A method according to claim 7 wherein said step of receiving panelboard information comprises the step of receiving feed-thru panelboard information including at least one of feed-thru option, feed-thru amperage, feed-thru interrupt rating, and lug/TVSS.

10] A method according to claim 7 wherein said step of receiving panelboard information comprises the step of receiving enclosure panelboard information including at least one of box and front.

11] A method according to claim 1 wherein said step of downloading information related to the panelboard comprises the step of downloading the accessories selected for the product.

12] A method according to claim 1 wherein said step of downloading information related to the panelboard comprises the step of downloading a list price for the product.

13] A method according to claim 1 wherein said step of downloading information related to the panelboard comprises the step of generating a quotation for the panel board.

14] A method according to claim 1 further comprising the step of validating configuration compatibility based on the received product specification information to determine whether a resulting product incorporating a panelboard having the received product specifications is capable of meeting parameters of the product.

15] A method according to claim 14 further comprising the step of guiding the user, if the resulting product does not meet the parameters of the product, to a correct panelboard configuration.

16] A method according to claim 1 further comprising the step of guiding the user to a compatible product.

17] A method according to claim 1 wherein said step of receiving product specification information from a user via the device comprises the step of receiving at least one of industrial, commercial, and residential product specification information from the user.

18] A system for facilitating selection of a panelboard, said system comprising:
a device; and
a server connected to said device and configured to receive panelboard information data from a user via said device, the panelboard information including at least one of a feature of the panelboard, a panel build of the panelboard, a branch breaker of the panelboard, and an accessory of the panelboard, said server further configured to identify stored panelboard information data that matches the panelboard information data entered by the user.

19] A system according to claim 18 wherein said server further configured to select at least one panelboard from the stored panelboard information data which matches the panelboard identification data entered by the user.

20] A system according to claim 18 wherein said server further configured to select at least one panelboard that includes at least one accessory for the product.

21] A system according to claim 18 wherein said server further configured to:
determine whether a selected bus material is available for the selected panelboard configuration; and
display a message if the selected bus material is not available for the selected panelboard configuration.

22] A system according to claim 18 wherein said server further configured to:
determine whether a selected number of circuits is available for the selected panelboard configuration; and
display a message if a panelboard is suggested that has a larger number of circuits available than the number of circuits selected.

23] A system according to claim 18 wherein said server further configured to generate a quotation for each selected panelboard.

24] A system according to claim 18 wherein said server further configured to accept a purchase order for the panelboard after the purchase order has been authenticated against pre-determined criteria.

25] A system according to claim 18 wherein said server and said device are connected via at least one of a wide area network, a local area network and the Internet.

26] A computer programmed to:
prompt a user to access a network-based panelboard selection application;
prompt a user to enter product specification information pertaining to panelboards;
compare the entered information with stored panelboard information;
select at least one panelboard which matches the received product specification information; and
download information related to the panelboard.

27] A computer in accordance with claim 26 further programmed to receive panelboard interior information for the product.

28] A computer in accordance with claim 26 further programmed to display a message if a selection is not available for the selected panelboard configuration.

29] A computer in accordance with claim 26 further programmed to download selected accessories for the product.

30] A computer in accordance with claim 26 further programmed to generate a quotation for the panelboard.

31] A computer in accordance with claim 26 further programmed to validate configuration compatibility based on the received product specification information to determine whether a resulting product incorporating a panelboard having the received product specifications is capable of meeting parameters of the product.

32] Apparatus comprising:
means for receiving product specification information from a user via a device;
means for comparing the received product specification information with pre-stored panelboard information;
means for selecting at least one panelboard which matches the received product specification information; and
means for transmitting the information related to the panelboard to the user.

33] Apparatus in accordance with claim 32 further comprising means for providing a recommendation regarding a suitable panelboard.

34] Apparatus in accordance with claim 32 further comprising means for displaying a message if a selection is not available for the selected panelboard configuration.

35] Apparatus in accordance with claim 32 further comprising means for displaying a recommendation regarding suggested product if a selection is not available for the selected panelboard configuration.

36] Apparatus in accordance with claim 32 further comprising means for generating a quotation for the selected panelboard.
